(19) United States
(12) Patent Application Publication
(10) Pub. No.: US 2024/0214175 A1
(43) Pub. Date: Jun. 27, 2024

(54) WIRELESS COMMUNICATION DEVICE AND OPERATING METHOD OF THE SAME

(71) Applicant: SAMSUNG ELECTRONICS CO., LTD., SUWON-SI (KR)

(72) Inventors: Minki Ahn, Suwon-si (KR); Jung Woon Lee, Suwon-si (KR)

(21) Appl. No.: 18/543,379

(22) Filed: Dec. 18, 2023

(30) Foreign Application Priority Data
Dec. 27, 2022 (KR) 10-2022-0186020

(51) Int. Cl. H04L 5/00; H04B 1/30; H04B 17/336

(52) U.S. Cl. CPC H04L 5/0098; H04B 1/30; H04B 17/336; H04B 2001/305

(57) ABSTRACT

A first wireless communication apparatus includes a transceiver including a direct current (DC) component filter configured to remove a DC component of a first data signal received from a second wireless communication apparatus via a channel and output a corresponding second data signal, and a measurement circuit configured to determine a target subcarrier set based on a carrier frequency offset with respect to the second data signal, and measure noise and a signal-to-noise ratio (SNR) of the second data signal using the target subcarrier set.

### CROSS-REFERENCE TO RELATED APPLICATION

This application is based on and claims priority under 35 U.S.C. § 119 to Korean Patent Application No. 10-2022-0186020, filed on Dec. 27, 2022 in the Korean Intellectual Property Office, the disclosure of which is incorporated by reference herein in its entirety.

### TECHNICAL FIELD

This disclosure relates generally to a wireless communication device, and more particularly, to a wireless communication device performing data communication with other wireless communication devices in a wireless communication system and an operating method of the wireless communication device.

### DISCUSSION OF RELATED ART

As an example of wireless communication, a wireless local area network (WLAN) is technology that connects two or more devices to each other by using a wireless signal transmission method, and the WLAN technology is based on the Institute of Electrical and Electronics Engineers (IEEE) 802.11 standard. The 802.11 standard has evolved into 802.11b, 802.11a, 802.11g, 802.11n, 802.11ac, and 802.11ax, or the like, and may support a high transmission speed by using orthogonal frequency-division multiplexing (OFDM) technology.

When a WLAN system supports high transmission speed, wireless communication devices within the WLAN system may exhibit communication performance deterioration due to mutual carrier frequency offset.

### SUMMARY

Embodiments of the inventive concept relate to a wireless communication device measuring noise and a signal-to-noise ratio (SNR) of a data signal considering a carrier frequency offset of the data signal received to prevent communication performance deterioration due to the carrier frequency offset, and an operating method of the wireless communication device.

According to an aspect of the inventive concept, there is provided a first wireless communication apparatus including a transceiver including a direct current (DC) component filter configured to remove a DC component of a first data signal received from a second wireless communication apparatus via a channel and output a corresponding second data signal, and a measurement circuit configured to determine a target subcarrier set based on a carrier frequency offset with respect to the second data signal, and measure noise and a signal-to-noise ratio (SNR) of the second data signal using the target subcarrier set.

According to another aspect of the inventive concept, there is provided a first wireless communication apparatus including a transceiver including a direct current (DC) component filter configured to remove a DC component of a first data signal received from a second wireless communication apparatus via a channel and output a corresponding second data signal, and a measurement circuit configured to perform a measurement operation on the second data signal using a valid subcarrier set of subcarriers represented by index values, among subcarriers included in the second data signal, when a carrier frequency offset with respect to the second data signal exceeds a threshold.

According to another aspect of the inventive concept, there is provided an operating method of the first wireless communication apparatus including receiving a first data signal from a second wireless communication apparatus via a channel, generating a second data signal by removing a direct current (DC) component of the first data signal, determining a target subcarrier set based on a carrier frequency offset with respect to the second data signal, and measuring a signal-to-noise ratio (SNR) and noise using the target subcarrier set.

### BRIEF DESCRIPTION OF THE DRAWINGS

Embodiments will be more clearly understood from the following detailed description taken in conjunction with the accompanying drawings in which:

FIG. 1 is a diagram of a wireless communication system according to an embodiment;

FIG. 2 is a block diagram of a wireless communication system according to an embodiment;

FIGS. 3A and 3B are diagrams of interference generated according to a carrier frequency offset;

FIG. 4 is a diagram of a frame format of a data signal in the wireless communication system of FIG. 2;

FIG. 5 is a flowchart of an operating method of a first wireless communication apparatus, according to an embodiment;

FIG. 6 is a flowchart of an operating method of a first wireless communication apparatus, according to an embodiment;

FIGS. 7 and 8 are flowcharts of embodiments of operation S120 in FIG. 6;

FIG. 9 is a flowchart of an operating method of a first wireless communication apparatus, according to an embodiment;

FIGS. 10A and 10B are tables of operations of a first wireless communication apparatus, according to embodiments;

FIG. 11 is a flowchart of an operating method of a first wireless communication apparatus, according to an embodiment;

FIG. 12 is a flowchart of an operating method of a first wireless communication apparatus, according to an embodiment;

FIG. 13A is a diagram of a carrier frequency offset adjustment operation, and FIG. 13B is a diagram of a relationship between a measurement operation and a carrier frequency offset adjustment operation, according to embodiments; and

FIG. 14 is a conceptual diagram of an Internet of Things (IoT) network system, to which the embodiments of the inventive concept are applied.

### DETAILED DESCRIPTION OF EMBODIMENTS

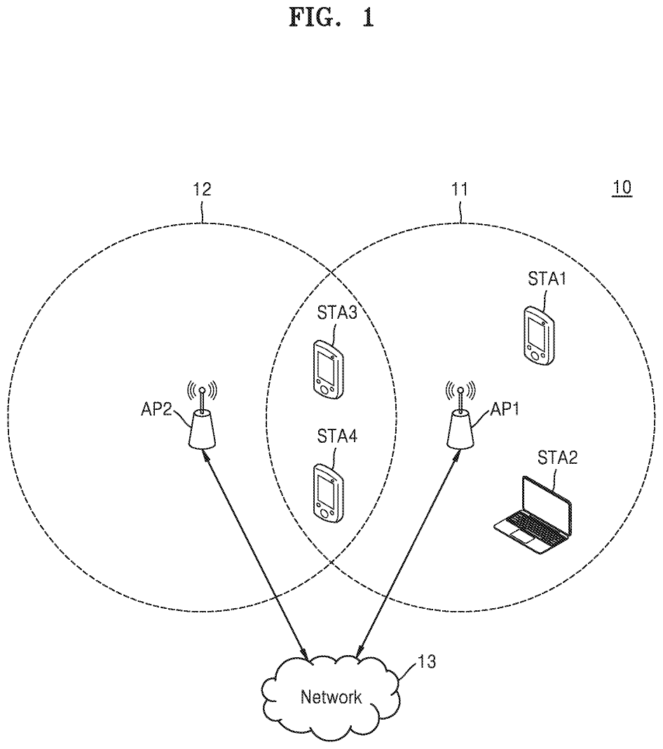

FIG. 1 is a diagram of a wireless communication system, 10, according to an embodiment. The wireless communication system 10 may represent a wireless local area network (WLAN) system.

Hereinafter, in describing embodiments of the inventive concept in detail, an orthogonal frequency-division multiplexing (OFDM) or OFDM-access (A) (OFDMA)-based wireless communication system, in particular, the IEEE 802.11 standard will be as a main target. However, a main subject of the inventive concept may be applicable with some modifications within the scope of the inventive concept to other communication systems having similar technical features and channel types (for example, long term evolution (LTE), LTE-advanced (A) (LTE-A), new radio (NR), wireless broadband (WiBro), and a cellular system such as global system for mobile communication (GSM), and a near field communication system such as Bluetooth and near field communication (NFC)), as determined by one of ordinary skill in the art.

Herein, a “subcarrier set” may be described interchangeably as either a set of subcarriers or a set of index values, each representing a subcarrier.

Referring to FIG. 1, the wireless communication system 10 may include first and second access points AP1 and AP2 and first through fourth stations STA1 through STA4. The first and second access points AP1 and AP2 may be connected to a network 13 such as the Internet, an internet protocol (IP) network, or other arbitrary networks. The first access point AP1 may provide a connection to the network 13 to the first through fourth stations STA1 through STA4 in a first coverage area 11, and the second access point AP2 may also provide a connection to the network 13 to the third and fourth stations STA3 and STA4 in a second coverage area 12. In some embodiments, the first and second access points AP1 and AP2 may communicate with at least one of the first through fourth stations STA1 through STA4 based on wireless fidelity (WiFi) or other arbitrary WLAN connection technology.

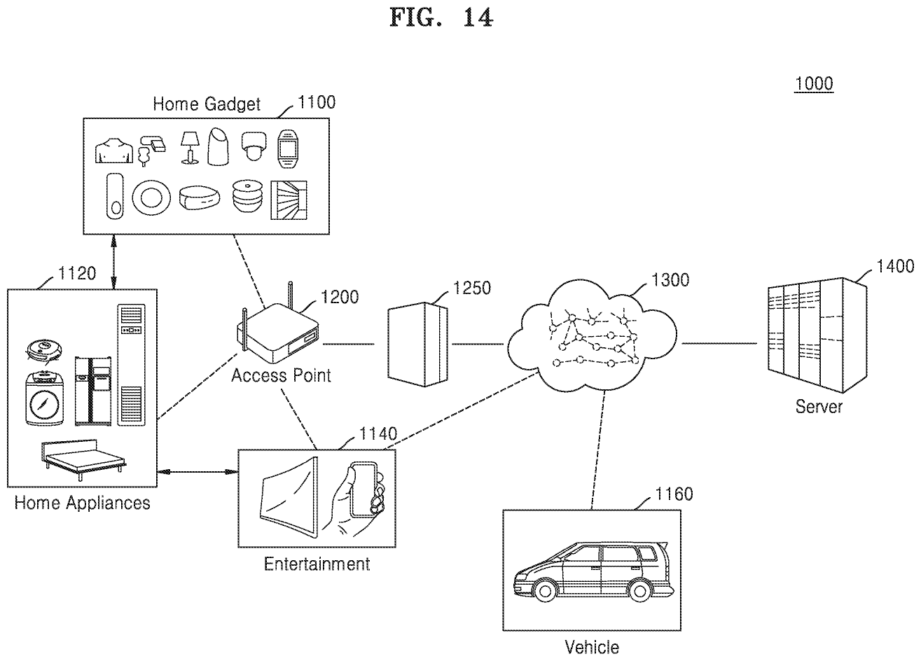

An access point may be referred to as a router, a gateway, or the like, and a station may be referred to as a mobile station, a subscriber station, a terminal, a mobile terminal, a wireless terminal, user equipment, a user, etc. Examples of a station may include a mobile device, such as a mobile phone, a laptop computer, and a wearable device; and a stationary device, such as a desktop computer and a smart TV. Other examples of an access point and a station are described below with reference to FIG. 14.

The first station STA1 may perform data communication with the first access point AP1. Herein, the first station STA1 may be referred to as a first wireless communication device, and the first access point AP1 may be referred to as a second wireless communication device. The first station STA1 may generate a second data signal after filtering, for removing the direct current (DC) component, the first data signal received from the first access point AP1.

In an embodiment, the first station STA1 may determine a target subcarrier set based on a carrier frequency offset of the second data signal, and may perform a measurement operation to measure noise and a signal-to-noise ratio (SNR) on the second data signal by using the target subcarrier set. Herein, noise may also be referred to as noise power. For example, the carrier frequency offset may be generated by a mismatch between the frequency of a local oscillator of the first station STA1 and the frequency of a local oscillator of the first access point AP1. The target subcarrier set may be represented by index values corresponding to respective subcarriers subject to a measurement operation, among all the subcarriers included in the second data signal.

The first station STA1 according to an embodiment may perform an accurate measurement operation by measuring the noise and the SNR of the second data signal by selectively using subcarriers with little impact of interference caused by the carrier frequency offset, and may thereby prevent communication performance deterioration.

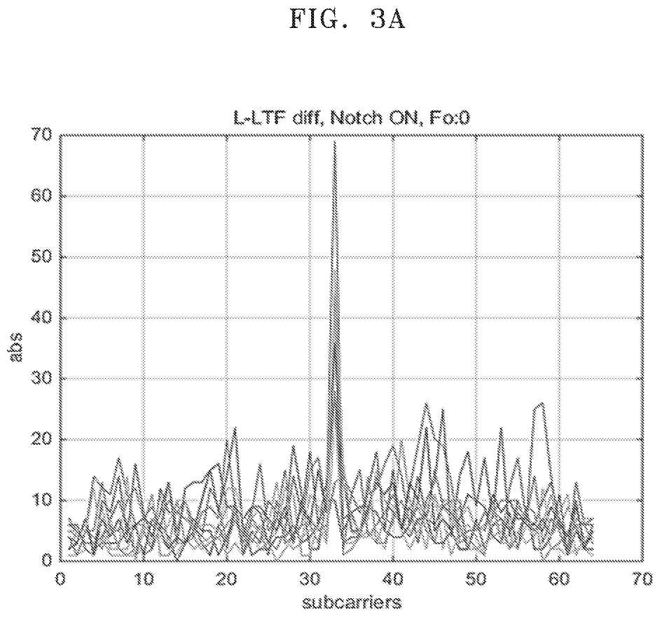

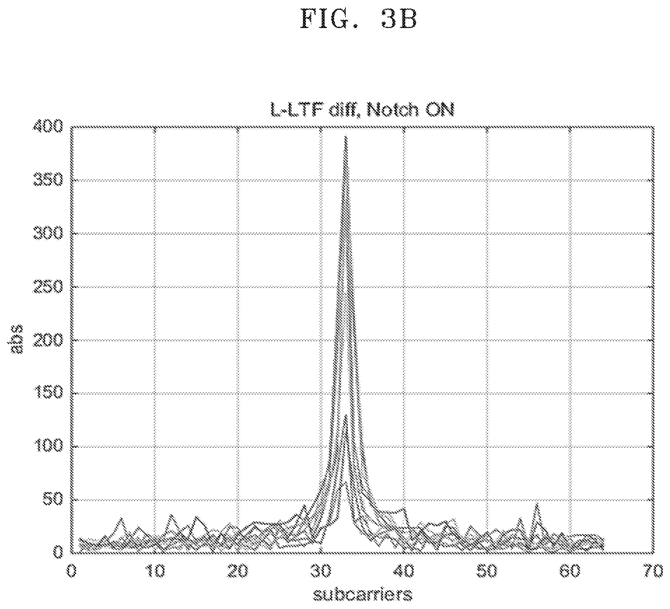

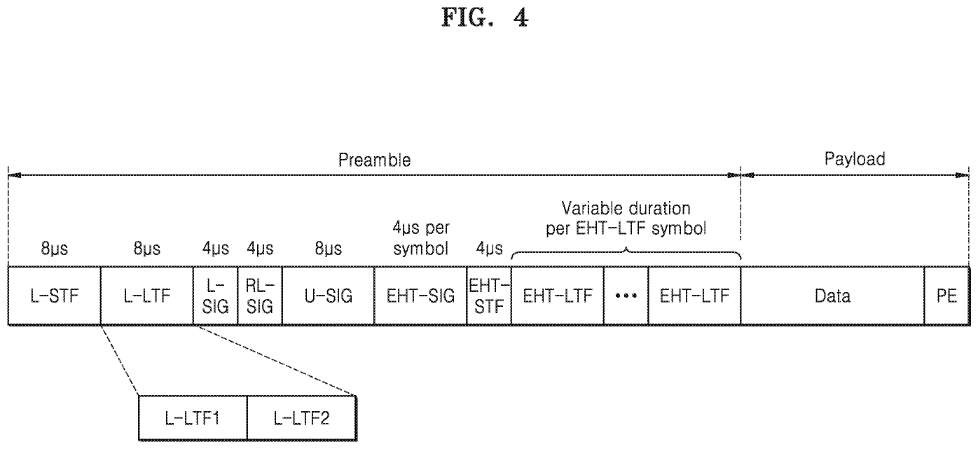

The interference issue due to the carrier frequency offset is described in detail below with reference to FIGS. 3A and 3B, and the noise and SNR measurement method of the first station STA1 is described in detail below with reference to FIG. 4.

In other examples, the measurement operation according to the technical idea of the inventive concept may be performed in other wireless communication devices, such as the first, second, and third stations STA2 through STA4, the first access point AP1, and the second access point AP2 in the wireless communication system 10, in addition to the first station STA1.

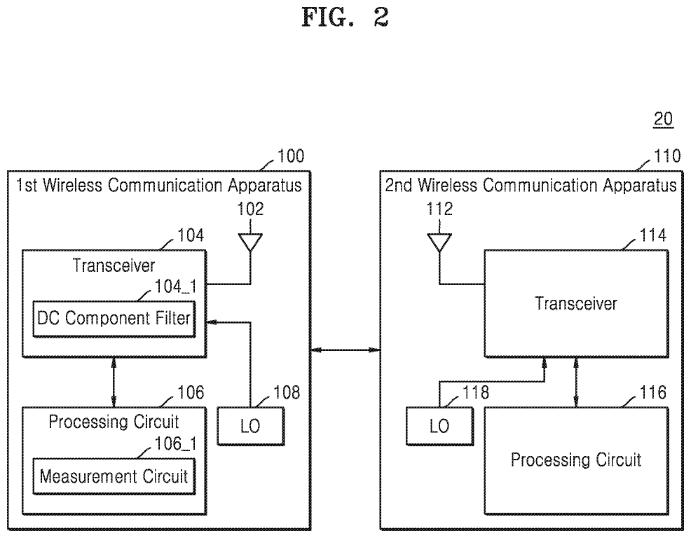

FIG. 2 is a block diagram of a wireless communication system 20 according to an embodiment, FIGS. 3A and 3B are diagrams of interference generated according to the carrier frequency offset, and FIG. 4 is a diagram of a frame format of a data signal in the wireless communication system 20 of FIG. 2. The block diagram of FIG. 2 illustrates a first wireless communication apparatus 100 and a second wireless communication apparatus 110 communicating with each other in the wireless communication system 20. Each of the first wireless communication apparatus 100 and the second wireless communication apparatus 110 may be an arbitrary apparatus communicating in the wireless communication system 20, and may be referred to as an apparatus for wireless communication. Each of the first wireless communication apparatus 100 and the second wireless communication apparatus 110 may be an access point or station of a WLAN system.

Referring to FIG. 2, the first wireless communication apparatus 100 may include an antenna 102, a transceiver 104, a processing circuit 106, and a local oscillator (LO) 108. In some embodiments, the antenna 102, the transceiver 104, the processing circuit 106, and the LO 108 may be included in one package, or may also be respectively included in different packages. The second wireless communication apparatus 110 may also include an antenna 112, a transceiver 114, a processing circuit 116, and an LO 118. Hereinafter, duplicate descriptions of the first wireless communication apparatus 100 and the second wireless communication apparatus 110 are omitted. In addition, hereinafter, descriptions are given mainly on the premise of an example, in which the first wireless communication apparatus 100 receives the first data signal from the second wireless communication apparatus 110.

The antenna 102 may receive the first data signal from the second wireless communication apparatus 110 and provide the received first data signal to the transceiver 104. In some embodiments, the antenna 102 may also be a phased array for beamforming. The transceiver 104 may include a DC component filter 104_1, which may remove the DC component of the first data signal (e.g., one or more centralized subcarriers with respect to the frequency axis) and output the remaining signal components as the second data signal. The DC component filter 104_1 may be a DC notch filter. The transceiver 104 may perform frequency down conversion on the second data signal based on the frequency signal received from the LO 108. The transceiver 104 may further include an analog circuit, such as a low noise amplifier, a mixer, and a power amplifier, and the transceiver 104 may additionally perform a processing operation on the first data signal or the second data signal under control of the processing circuit 106.

The processing circuit 106 may include a measurement circuit 106_1. In an embodiment, the measurement circuit 106_1 may determine the target subcarrier set based on the carrier frequency offset of the second data signal, and perform a measurement operation on the second data signal using the target subcarrier set. The measurement operation on the second data signal may include an operation of performing a high-speed Fourier transform on the second data signal, and measuring the noise and SNR using at least one of the subcarriers of the second data signal converted into the frequency domain. For example, the carrier frequency offset may be caused by an inconsistency between a first frequency of the LO 108 of the first wireless communication apparatus 100 and a second frequency of the LO 118 of the second wireless communication apparatus 110, and may be defined as the difference between the first frequency and the second frequency.

Referring further to FIG. 3A, it may be identified that when there is no carrier frequency offset, that is, when the carrier frequency offset corresponds to ‘0’, there is less interference caused by the removal of DC components from all subcarriers included in the second data signal.

On the other hand, referring further to FIG. 3B, it may be identified that when there is the carrier frequency offset, very high interference occurs in some subcarriers around the DC component of the subcarriers included in the second data signal. The reason for this phenomenon may be because the DC component filter 104_1 removes the DC component of the first data signal on the premise that there is no carrier frequency offset, but in reality, subcarriers around the DC component of the subcarriers of the first data signal are removed. There is an issue that the measurement circuit 106_1 may not perform an accurate measurement operation on the second data signal due to high interference generated in some subcarriers around the DC component.

Returning to FIG. 2, the measurement circuit 106_1 may perform a measurement operation on the second data signal considering the influence of the carrier frequency offset in FIG. 3B. In an embodiment, the measurement circuit 106_1 may determine the target subcarrier set based on the carrier frequency offset of the second data signal, and measure the noise and SNR for the second data signal using the target subcarrier set.

For example, the measurement circuit 106_1 may determine a valid subcarrier set as the target subcarrier set when the carrier frequency offset exceeds a threshold, and may determine the basic subcarrier set as the target subcarrier set when the carrier frequency offset is less than the threshold.

Herein, the basic subcarrier set may include index values indicating first subcarriers, which are a subset of the set of subcarriers included in the second data signal. For example, when there is no carrier frequency offset, the first subcarriers may be pre-selected to increase the accuracy of the measurement operation on the second data signal. In addition, herein, the valid subcarrier set may be a set of second subcarriers, which set is a subset of the first subcarriers included in the second data signal. For example, when the carrier frequency offset exceeds the threshold, the second subcarriers may be pre-selected to increase the accuracy of the measurement operation on the second data signal. The second subcarriers may correspond to the remainder of the first subcarriers, in which some of the subcarriers with high interference are excluded.

In some embodiments, the first wireless communication apparatus 100 may store first information related to the valid subcarrier set in advance in a memory (not illustrated), and may read the first information from the memory (not illustrated) to use the read first information for the measurement operation on the second data signal.

Based on the indexes of subcarriers illustrated in FIGS. 3A and 3B, the basic subcarrier set may include indexes of sixth through thirty first and thirty third through fifty eighth subcarriers as {6:31, 33:58}, and the valid subcarrier set may include indexes of sixth through twenty fourth and fortieth through fifty eighth subcarriers as {6:24, 40:58}.

In an embodiment, the indexes included in the valid subcarrier set or the number of indexes may be determined based on interference generated by the carrier frequency offset, and may vary depending on various factors, such as the hardware configuration of the first wireless communication apparatus 100, the channel state of the second wireless communication apparatus 110, and communication environment of the first wireless communication apparatus 100.

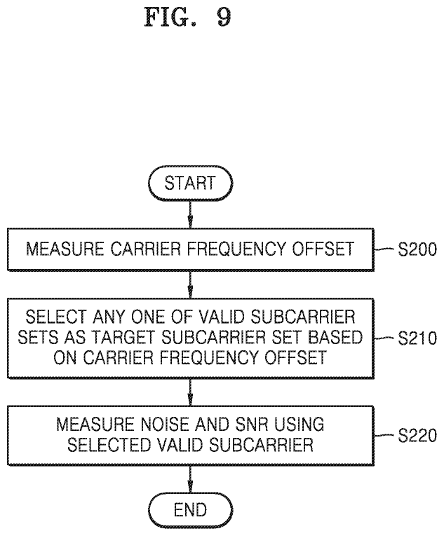

In an embodiment, when the carrier frequency offset exceeds the threshold, the measurement circuit 106_1 may select any one of a plurality of valid subcarriers as a target subcarrier set, and perform a measurement operation on the second data signal. For example, the measurement circuit 106_1 may select any one of the plurality of valid subcarrier sets as the target subcarrier set, based on at least one of the carrier frequency offset and the channel state of the second wireless communication apparatus 110. Detailed embodiments for this case are described below with reference to FIGS. 9 through 11. In some embodiments, the first wireless communication apparatus 100 may store in advance second information related to the plurality of valid subcarrier sets in a memory (not illustrated), and may read the second information from a memory (not illustrated) and use the read second information for the measurement operation.

Referring further to FIG. 4, the frame format of the second data signal (or the first data signal) may include a preamble including training fields and signaling fields, and a payload including data fields. In the preamble, the frame format may include a legacy-short training field (L-STF), a legacy-long training field (L-LTF), a legacy-signal (L-SIG) field, a repeated legacy-signal (RL-SIG) field, a universal signal (U-SIG) field, an extremely high throughput-signal (EHT-SIG) field, an extremely high throughput-short training field (EHT-STF), and an extremely high throughput-long training field (EHT-LTF). In addition, the frame format may, in a payload, include a data field and a packet extension (PE) field.

On the other hand, the L-LTF may include the same pattern data, and may include a first L-LTF L-LTF1 and a second L-LTF L-LTF2, which are continuous. Although not illustrated in FIG. 4, the L-LTF may also further include at least one other field. The measurement circuit 106_1 may measure the noise and SNR for the second data signal in the time domain or frequency domain using the first L-LTF L-LTF1 and the second L-LTF L-LTF2.

For example, in the frequency domain, the first L-LTF L-LTF1 and the second L-LTF L-LTF2 may be defined by Formula 1 below. Hereinafter, in formulas below, ‘L-LTF1’ may be represented as ‘L_LTF1’, and ‘L-LTF2’ may be represented as ‘L_LTF2’.

$$L\_LTF 1 ( k ) = h ( k ) s ( k ) + {n}_{1} \qquad [ Formula 1 ]$$

h(k), s(k), and nₗ (l=1, 2) may represent the channel response of a k^{th} subcarrier, the L-LTF sequence of the k^{th} subcarrier, and additive white Gaussian noise (AWGN) of the k^{th} subcarrier, respectively.

In addition, an average P_{sig,t} of the sums of the received powers of the first L-LTF L-LTF1 and the second L-LTF L-LTF2 or an average P_{nois,t} of the differences between the received powers thereof may be defined by Formula 2 below.

$${P}_{sig , t} = \frac{{\sum }_{i ∈ ω}^{N} {\vert L\_LTF 1 ( i ) + L\_LTF 2 ( i ) \vert}^{2}}{N} \qquad [ Formula 2 ]$$

$${P}_{nois , t} = \frac{{\sum }_{i ∈ ω}^{N} {\vert L\_LTF 1 ( i ) - L\_LTF 2 ( i ) \vert}^{2}}{N}$$

where ω is the target subcarrier set, and N is the number of index values of the target subcarrier set. In an embodiment, the measurement circuit 106_1 may measure noise of the second data signal to match the average of the differences of the received powers P_{nois,t}. As an example, the measurement circuit 106_1 may measure the noise of the second data signal as the average of the differences of the received noise power P_{nois,t}.

The SNR of the second data signal may be defined by Formula 3 below by using Formula 2.

$${SNR}_{dB} = 10 \cdot {log}_{10} ( \frac{{P}_{sig , t}}{2 * {P}_{nois , t}} ) \qquad [ Formula 3 ]$$

In an embodiment, the measurement circuit 106_1 may measure the SNR of the second data signal based on the average of the sums P_{sig,t} and the average of the differences P_{nois,t}.

In an embodiment, the noise measured by the measurement circuit 106_1 may be used for a whitening operation for symbol detection of the second data signal. In addition, the SNR measured by the measurement circuit 106_1 may be used for design or setting for optimal reception. For example, the measured SNR may be used to calculate the optimal weight for maximum ratio combining (MRC) or to determine the optimal smoothing filter coefficient for channel estimation.

The processing circuit 106 may extract information transmitted by the second wireless communication apparatus 110 by processing the second data signal received from the transceiver 104. For example, the processing circuit 106 may extract information by demodulating and/or decoding the second data signal.

On the other hand, the second wireless communication apparatus 110 may receive the first data signal from the first wireless communication apparatus 100, and in this case, the embodiments described above of the first wireless communication apparatus 100 may also be applied to the second wireless communication apparatus 110.

The measurement circuit 106_1 according to an embodiment may accurately measure the noise and SNR of the data signal by using subcarriers excluding the subcarriers, which are expected to be greatly interfered by the carrier frequency offset corresponding to the subcarrier frequency difference between the first wireless communication apparatus 100 and the second wireless communication apparatus 110. In this manner, the first wireless communication apparatus 100 may perform a reliable communication operation based on the accurately measured noise and SNR.

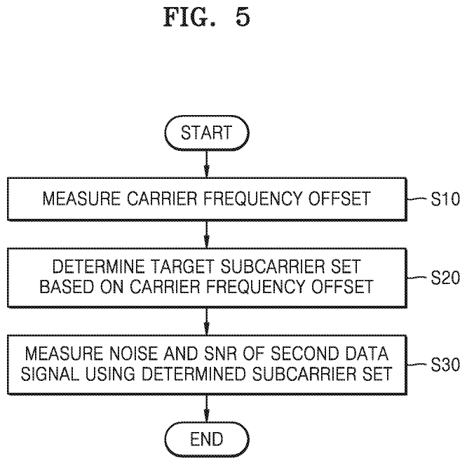

FIG. 5 is a flowchart of an operating method of the first wireless communication apparatus, according to an embodiment.

Referring to FIG. 5, in operation S10, the first wireless communication apparatus may measure the carrier frequency offset with respect to the second wireless communication apparatus. In an embodiment, the first wireless communication apparatus may receive the first data signal from the second wireless communication apparatus, and measure the carrier frequency offset by using the first data signal. In an embodiment, an operation of measuring the carrier frequency offset may be performed periodically or aperiodically. In some configurations, operation S10 may not be performed each time the first wireless communication apparatus performs a measurement operation of the noise and SNR. Instead, the carrier frequency offset of a prior measurement may be retrieved from memory.

In operation S20, the first wireless communication apparatus may determine the target subcarrier set based on the carrier frequency offset.

In operation S30, the first wireless communication apparatus may measure the noise and SNR of the second data signal using the target subcarrier set determined in operation S20. As described above, the second data signal may be generated by removing the DC component from the first data signal received from the second wireless communication apparatus.

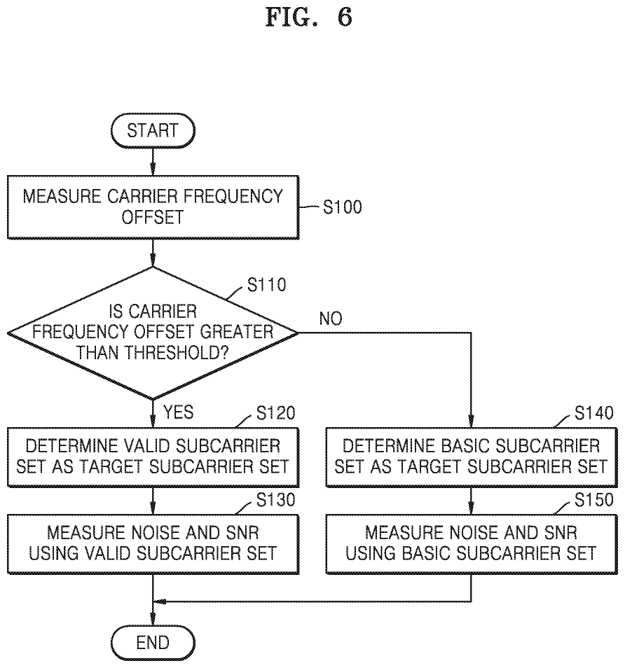

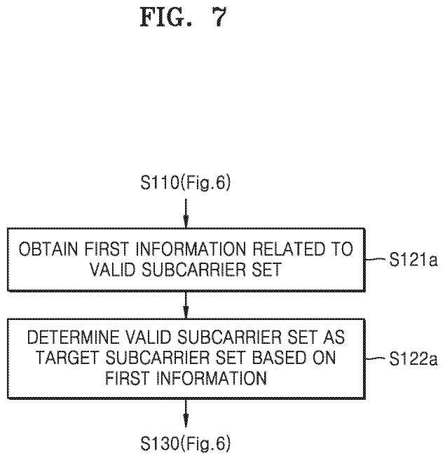

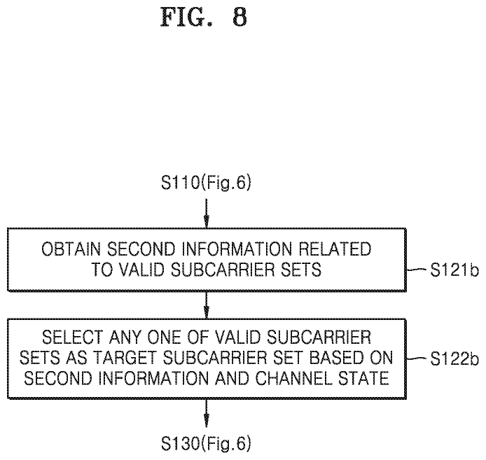

FIG. 6 is a flowchart of an operating method of the first wireless communication apparatus 100, according to an embodiment.

In operation S100, the first wireless communication apparatus 100 may measure the carrier frequency offset with respect to the second wireless communication apparatus 110.

In operation S110, the first wireless communication apparatus 100 may determine whether the carrier frequency offset measured in operation S100 exceeds the threshold.

When the result of operation S110 is ‘YES’, the first wireless communication apparatus 100 may determine the valid subcarrier set as the target subcarrier set after operation S120.

In operation S130, the first wireless communication apparatus 100 may measure the noise and SNR of the second data signal by using the valid subcarrier set.

When the result of operation S110 is ‘NO’, the first wireless communication apparatus 100 may determine the basic subcarrier set as the target subcarrier set after operation S140.

In operation S150, the first wireless communication apparatus 100 may measure the noise and SNR of the second data signal by using the basic subcarrier set.

In an embodiment, the valid subcarrier set may be represented by index values of the second subcarriers obtained by excluding selected subcarriers (e.g., centrally located subcarriers with respect to the frequency axis, among all the subcarriers) from the first subcarriers of the basic subcarrier set. The selected subcarriers may be subcarriers in which large interference occurs when the carrier frequency offset exceeds the threshold value.

FIGS. 7 and 8 are flowcharts of embodiments of operation S120 in FIG. 6.

Referring to FIG. 7, the first wireless communication apparatus 100 may obtain the first information related to the valid subcarrier sets in operation S121a following operation S110 in FIG. 6. The valid subcarrier sets may be preset and stored in a memory of the first wireless communication apparatus 100 as the first information, and the first wireless communication apparatus 100 may obtain the first information by reading the first information from the memory.

In operation S122a, the first wireless communication apparatus 100 may determine the valid subcarrier set as the target subcarrier set based on the first information obtained in operation S121a. Thereafter, operation S130 in FIG. 6 may follow.

Referring further to FIG. 8, the first wireless communication apparatus 100 may obtain the second information related to the valid subcarrier sets in operation S121b following operation S110 in FIG. 6. The valid subcarrier sets may be preset and stored in the memory of the first wireless communication apparatus 100 as the second information, and the first wireless communication apparatus 100 may obtain the second information by reading the second information from the memory. In an embodiment, each of the valid subcarrier sets may be different from each other. For example, the composition of index values of each of the valid subcarrier sets may be different. When a first valid subcarrier set is {1, 2, 3}, and a second valid subcarrier set is {2, 3, 4} (each index value representing a subcarrier), it may be understood that the composition of the index values of the first and second valid subcarrier sets is different. In another example, the number of index values within each of the valid subcarrier sets may be different from each other.

In operation S122b, the first wireless communication apparatus 100 may determine any one of the valid subcarrier sets as the target subcarrier set based on the second information and the channel state obtained in operation S121b. The channel state may include a state of a channel with respect to the second wireless communication apparatus 110 transmitting the first data signal to the first wireless communication apparatus 100. The first wireless communication apparatus 100 may select, as the target subcarrier set, the optimal valid subcarrier set of the valid subcarrier sets additionally considering the channel state. Thereafter, operation S130 in FIG. 6 may follow.

FIG. 9 is a flowchart of an operating method of the first wireless communication apparatus 100, according to an embodiment.

Referring to FIG. 9, in operation S200, the first wireless communication apparatus 100 may measure the carrier frequency offset with respect to the second wireless communication apparatus 110. In some embodiments, operation S200 may be replaced with an operation of obtaining the carrier frequency offset from the memory of the first wireless communication apparatus 100.

In operation S210, the first wireless communication apparatus 100 may select, as the target subcarrier set, any one of the valid subcarrier sets based on the carrier frequency offset measured in operation S200.

In operation S220, the first wireless communication apparatus 100 may measure the noise and SNR by using the valid subcarrier set selected in operation S210.

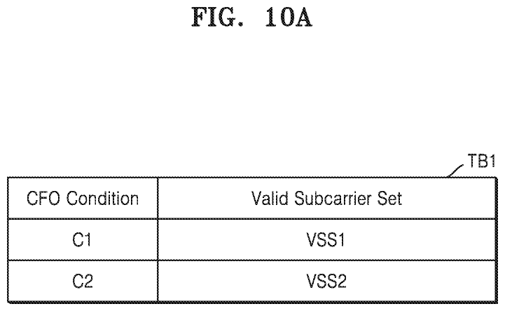

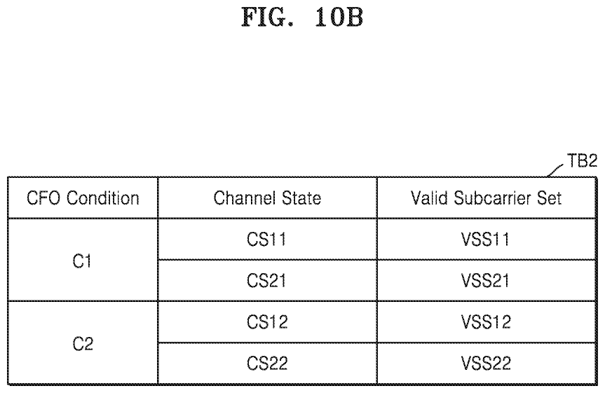

FIGS. 10A and 10B are tables of operations of the first wireless communication apparatus 100, according to embodiments.

Referring to a first table TB1 of FIG. 10A, the first wireless communication apparatus 100 may select a first valid subcarrier set VSS1 as the target subcarrier set when a carrier frequency offset condition matches a first condition C1. In addition, the first wireless communication apparatus 100 may select a second valid subcarrier set VSS2 as the target subcarrier set when the carrier frequency offset condition matches a second condition C2.

As illustrated in the first table TB1, the first wireless communication apparatus 100 may select one of the first and second valid subcarrier sets VSS1 and VSS2 as the target subcarrier set based on the carrier frequency offset.

Referring further to a second table TB2 of FIG. 10B, the first wireless communication apparatus 100 may select a first valid subcarrier set VSS11 as the target subcarrier set, when the carrier frequency offset condition is the first condition C1 and the channel state is a first state CS11. The first wireless communication apparatus 100 may select a second valid subcarrier set VSS21 as the target subcarrier set, when the carrier frequency offset condition is the first condition C1 and the channel state is a second state CS21. The first wireless communication apparatus 100 may select a third valid subcarrier set VSS12 as the target subcarrier set, when the carrier frequency offset condition is the second condition C2 and the channel state is a third state CS12. In addition, the first wireless communication apparatus 100 may select a fourth valid subcarrier set VSS22 as the target subcarrier set, when the carrier frequency offset condition is the second condition C2 and the channel state is a fourth state CS22.

As illustrated in the second table TB2 the first wireless communication apparatus 100 may select, as the target subcarrier set, one of the first through fourth subcarrier sets VSS1 through VSS4 based on the carrier frequency offset.

However, FIGS. 10A and 10B are only illustrative examples, and more or fewer valid subcarrier sets may be set, and any one of the valid subcarrier sets may be selected as the target subcarrier set based on various factors.

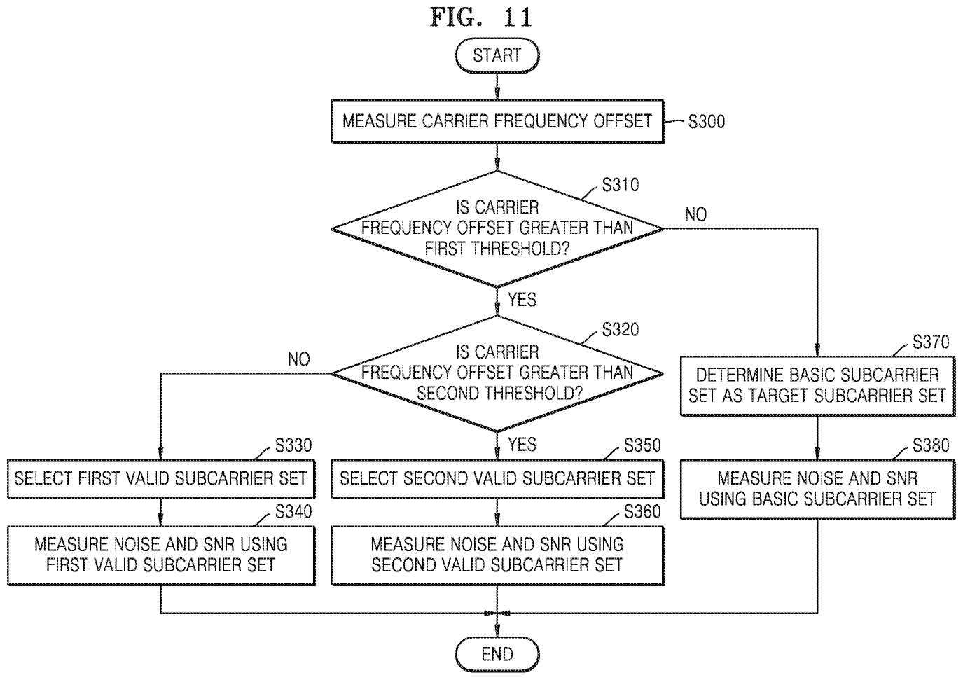

FIG. 11 is a flowchart of an operating method of the first wireless communication apparatus 100, according to an embodiment.

Referring to FIG. 11, in operation S300, the first wireless communication apparatus 100 may measure the carrier frequency offset with respect to the second wireless communication apparatus 110.

In operation S310, the first wireless communication apparatus 100 may determine whether the carrier frequency offset measured in operation S300 exceeds a first threshold.

When the result of operation S310 is ‘YES’, in operation S320 following operation S310, the first wireless communication apparatus 100 may determine whether the carrier frequency offset measured in operation S300 exceeds a second threshold.

When the result of operation S320 is ‘NO’, in operation S330 following operation S320, the first wireless communication apparatus 100 may determine the first valid subcarrier set as the target subcarrier set. The fact that the result of operation S320 is ‘NO’ may match the first condition C1 in FIG. 10A.

In operation S340, the first wireless communication apparatus 100 may measure the noise and SNR of the second data signal by using the first valid subcarrier set selected in operation S330.

When the result of operation S320 is ‘YES’, in operation S350 following operation S320, the first wireless communication apparatus 100 may select the second valid subcarrier set as the target subcarrier set. The fact that the result of operation S320 is ‘YES’ may match the second condition C2 in FIG. 10A. In an embodiment, the number of index values of the second valid subcarrier set may be less than the number of index values of the first valid subcarrier set. In some embodiments, because the second valid subcarrier set includes index values of subcarriers selected as having a small effect of interference due to the carrier frequency offset exceeding the second threshold, the composition of index values of the second valid subcarrier set may be different from the composition of index values of the first valid subcarrier set.

For example, based on the index values of the subcarriers described with reference to FIGS. 3A and 3B, the first valid subcarrier set may be defined as {6:28, 36:58} such that the number of index values thereof is 46, and the second valid subcarrier set may be defined as {6:24, 40:58} such that the number of index values thereof is 38.

In operation S360, the first wireless communication apparatus 100 may measure the noise and SNR of the second data signal using the second valid subcarrier set selected in operation S350.

When the result of operation S310 is ‘NO’, in operation S370 following operation S310, the first wireless communication apparatus 100 may determine the basic subcarrier set as the target subcarrier set.

In operation S380, the first wireless communication apparatus 100 may measure the noise and SNR of the second data signal using the basic subcarrier set selected in operation S370.

In an embodiment, the first and second thresholds may be system parameter values, which are preset in a wireless communication system including the first wireless communication apparatus 100. The first wireless communication apparatus 100 may obtain and store the first and second thresholds in the initial connection operation in the wireless communication system 10. In addition, in some embodiments, the first and second thresholds may also vary depending on the state of the wireless communication system 10.

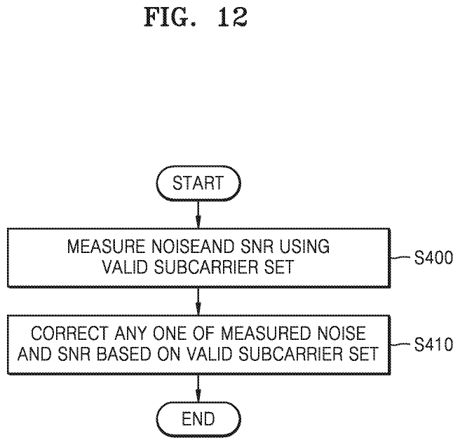

FIG. 12 is a flowchart of an operating method of the first wireless communication apparatus 100, according to an embodiment.

Referring to FIG. 12, in operation S400, the first wireless communication apparatus 100 may measure the noise and SNR using the valid subcarrier set instead of the basic subcarrier set, after having considered the carrier frequency offset.

In operation S410, the first wireless communication apparatus 100 may correct at least one of noise and SNR measured in operation S400 based on the valid subcarrier set. Because the number of index values in the valid subcarrier set is less than the number of index values in the basic subcarrier set, there may be fewer subcarrier samples used for measuring the noise and SNR.

In an embodiment, the first wireless communication apparatus 100 may correct at least one of the noise and SNR measured in operation S400 based on a difference in the number of index values (i.e., based on a difference in the number of subcarriers) between the basic subcarrier set and the valid subcarrier set.

When the number of valid subcarrier sets is two or more, the first wireless communication apparatus 100 may correct at least one of the noise and SNR measured in operation S400 based on the number of index values of the selected valid subcarrier set, or based on a combination of the index values.

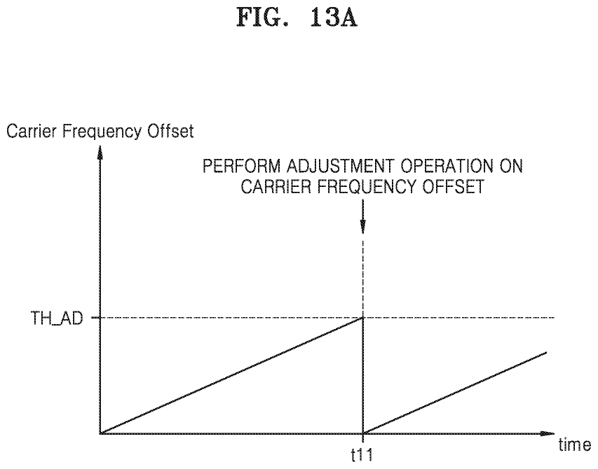

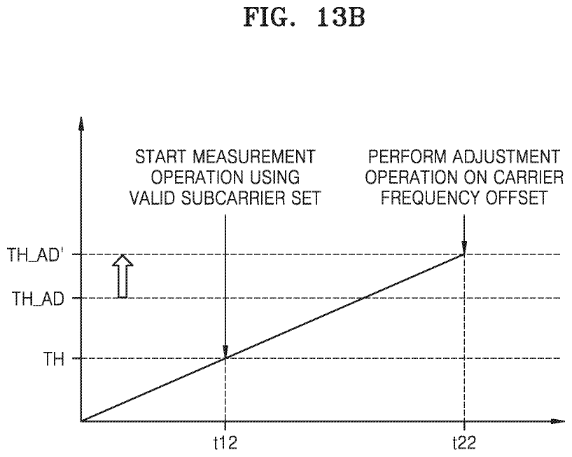

FIG. 13A is a diagram of the carrier frequency offset adjustment operation, and FIG. 13B is a diagram of a relationship between a measurement operation and the carrier frequency offset adjustment operation, according to embodiments.

Referring to FIG. 13A, the first wireless communication apparatus may measure the carrier frequency offset with respect to the second wireless communication apparatus, and perform an adjustment operation on the carrier frequency offset at a first time point t11, at which the measured carrier frequency offset exceeds a first adjustment threshold TH_AD. When the carrier frequency offset exceeds the first adjustment threshold TH_AD, the first wireless communication apparatus may adjust a frequency of the local oscillator to match a frequency of the local oscillator of the second wireless communication apparatus based on the carrier frequency offset.

Referring to FIG. 13B, the first wireless communication apparatus may perform a measurement operation based on the carrier frequency offset and an adjustment operation on the carrier frequency offset at the same time. The first wireless communication apparatus may measure the carrier frequency offset with respect to the second wireless communication apparatus, and at a first time point t12, at which the measured carrier frequency offset exceeds a threshold TH, may start the measurement operation by using the valid subcarrier set. Thereafter, the first wireless communication apparatus may continue to measure the carrier frequency offset periodically or aperiodically, and at a second time point t22, at which the measured carrier frequency offset exceeds a second adjustment threshold TH_AD′, may perform the adjustment operation on the carrier frequency offset.

The first wireless communication apparatus may increase the second adjustment threshold TH_AD′ above the first adjustment threshold TH_AD in FIG. 13A by performing the measurement operation based on the carrier frequency offset, and in this manner, may save resources consumed by a frequency adjustment operation, by reducing a frequency of the adjustment operation on the carrier frequency offset.

FIG. 14 is a conceptual diagram of an Internet of Things (IOT) network system 1000, to which embodiments of the inventive concept are applied.

Referring to FIG. 14, the IoT network system 1000 may include a plurality of IoT devices 1100, 1120, 1140, and 1160, an access point 1200, a gateway 1250, a wireless network 1300, and a server 1400. The IoT may be referred to as a network of objects using wired/wireless communication.

Each of the plurality of IoT devices 1100, 1120, 1140, and 1160 may form a group according to characteristics thereof. For example, the plurality of IoT devices 1100, 1120, 1140, and 1160 may be grouped into a home gadget group 1100, a home appliance/furniture group 1120, an entertainment group 1140, or a vehicle group 1160, etc. The plurality of IoT devices 1100, 1120, and 1140 may be connected to a communication network or other IoT devices via the access point 1200. The access point 1200 may be embedded in one IoT device. The gateway 1250 may change a protocol so that the access point 1200 is connected to an external wireless network. The plurality of IoT devices 1100, 1120, and 1140 may be connected to the external communication network via the gateway 1250. The wireless network 1300 may include the Internet and/or a public network. The plurality of IoT devices 1100, 1120, 1140, and 1160 may be connected to a server 1400 providing a certain service via the wireless network 1300, and a user may use the service by using at least one of the plurality of IoT devices 1100, 1120, 1140, and 1160.

According to the embodiments of the inventive concept, the plurality of IoT devices 1100, 1120, 1140, and 1160 may determine the target subcarrier set based on the carrier frequency offset for the received data signal, and perform the measurement operation on the noise and SNR by using the target subcarrier set. In this manner, the plurality of IoT devices 1100, 1120, 1140, and 1160 may perform an efficient and effective communication, and provide a good service to a user.

Various functions described above may be implemented or supported by one or more computer programs, each of which includes computer-readable program code and is executed on a computer-readable medium. The terms “application” and “program” may be referred to as one or more computer programs, software components, instruction sets, procedures, functions, objects, classes, instances, related data, or portions thereof suitable for implementation of suitable computer-readable program code. The term “computer-readable program code” may include all types of computer code including source code, object code, and executable code. The term “computer-readable medium” may include all types of non-transitory media accessible by a computer, such as read-only memory (ROM), random access memory (RAM), a hard disk drive, a compact disk (CD), a digital video disk (DVD), or some other type of memory. The term “non-transitory” computer-readable media excludes wired, wireless, optical, or other communication links that transmit transient electrical signals or other signals. The non-transitory computer-readable media may include media on which data is permanently stored, and media on which data is stored and later overwritten, such as a rewritable optical disk and an erasable memory device.

While the inventive concept has been particularly shown and described with reference to embodiments thereof, it will be understood that various changes in form and details may be made therein without departing from the spirit and scope of the following claims.

What is claimed is:

1. A first wireless communication apparatus comprising:
a transceiver including a direct current (DC) component filter configured to remove a DC component of a first data signal received from a second wireless communication apparatus via a channel and output a corresponding second data signal; and
a measurement circuit configured to determine a target subcarrier set based at least in part on a carrier frequency offset with respect to the second data signal, and measure noise and a signal-to-noise ratio (SNR) of the second data signal by using the target subcarrier set.

2. The first wireless communication apparatus of claim 1,
wherein the measurement circuit determines a valid subcarrier set as the target subcarrier set when the carrier frequency offset exceeds a threshold, and determines a basic subcarrier set as the target subcarrier set when the carrier frequency offset is equal to or less than the threshold.

3. The first wireless communication apparatus of claim 1,
wherein the basic subcarrier set comprises first subcarriers among subcarriers included in the second data signal, and
wherein the valid subcarrier set comprises second subcarriers among the first subcarriers.

4. The first wireless communication apparatus of claim 3, wherein the second subcarriers comprise subcarriers apart from the DC component of the first data signal of the first subcarriers by more than a certain frequency distance.

5. The first wireless communication apparatus of claim 1, wherein the measurement circuit selects any one of a plurality of valid subcarrier sets as a target subcarrier set, when the subcarrier frequency offset exceeds a threshold.

6. The first wireless communication apparatus of claim 5, wherein the measurement circuit selects, as a target subcarrier set, any one of the plurality of valid subcarrier sets based on at least one of the carrier frequency offset and a state of the channel.

7. The first wireless communication apparatus of claim 5, wherein the plurality of valid subcarrier sets comprise subcarriers represented by index values, among the subcarriers included in the second data signal, and
a number of index values of each of the plurality of valid subcarrier sets are different from each other.

8. The first wireless communication apparatus of claim 5,
wherein the threshold comprises a first threshold and a second threshold that is higher than the first threshold,
wherein the plurality of valid subcarrier sets comprise a first valid subcarrier set and a second valid subcarrier set having less subcarriers than the subcarriers of the first valid subcarrier set, and
wherein the measurement circuit selects the first valid subcarrier set as the target subcarrier set, when the carrier frequency offset exceeds the first threshold and is equal to or less than the second threshold.

9. The first wireless communication apparatus of claim 8, wherein the measurement circuit selects the second valid subcarrier set as the target subcarrier set, when the carrier frequency offset exceeds the second threshold.

10. The first wireless communication apparatus of claim 1, wherein the measurement circuit selectively performs a correction operation on at least one of the measured noise and SNR.

11. The first wireless communication apparatus of claim 1, wherein a frame format of the first data signal comprises first and second legacy-long training fields (L-LTFs) including same pattern data.

12. The first wireless communication apparatus of claim 1, wherein the DC component filter is implemented as a DC notch filter.

13. The first wireless communication apparatus of claim 1, wherein the carrier frequency offset is a result of a mismatch between a frequency of a local oscillator of the first wireless communication apparatus and a frequency of a local oscillator of the second wireless communication apparatus.

14. The first wireless communication apparatus of claim 1, further comprising a memory configured to store information about at least one valid subcarrier set, which is accessed to determine the target subcarrier set.

15. A first wireless communication apparatus comprising:
a transceiver including a direct current (DC) component filter configured to remove a DC component of a first data signal received from a second wireless communication apparatus via a channel and output a corresponding second data signal; and
a measurement circuit configured to perform a measurement operation on the second data signal using a valid subcarrier set of subcarriers represented by index values, among subcarriers included in the second data signal, when a carrier frequency offset with respect to the second data signal exceeds a threshold.

16. The first wireless communication apparatus of claim 15, wherein the threshold comprises a preset system parameter value.

17. The first wireless communication apparatus of claim 15, wherein the index values representing subcarriers of the valid subcarrier set, or a subset of the index values, are determined based on interference caused by the carrier frequency offset.

18. The first wireless communication apparatus of claim 15, wherein the measurement circuit corrects a result of the measurement operation based on a number of the index values representing subcarriers in the valid subcarrier set.

19. An operating method of the first wireless communication apparatus, the operating method comprising:
receiving a first data signal from a second wireless communication apparatus via a channel;
generating a second data signal by removing a direct current (DC) component of the first data signal;
determining a target subcarrier set based on a carrier frequency offset with respect to the second data signal; and
measuring a signal-to-noise ratio (SNR) and noise using the target subcarrier set.

20. The operating method of claim 19, wherein the determining of the target subcarrier set comprises determining a valid subcarrier set as the target subcarrier set when the carrier frequency offset exceeds a threshold.
